(19) United States
(12) Patent Application Publication
(10) Pub. No.: US 2023/0368477 A1
(43) Pub. Date: Nov. 16, 2023

(54) AUGMENTED AND MIXED REALITY SCREEN

(71) Applicant: Dmitrij Sergeevich Moskalev, Saint-Petersburg (RU)

(72) Inventor: Dmitrij Sergeevich Moskalev, Saint-Petersburg (RU)

(21) Appl. No.: 18/303,605

(22) Filed: Apr. 20, 2023

Related U.S. Application Data
(63) Continuation of application No. PCT/RU2020/000569, filed on Oct. 23, 2020.

(30) Foreign Application Priority Data
Oct. 23, 2020 (RU) 2020134874

(51) Int. Cl. G06T 19/00; G02B 5/18; G02B 27/42

(52) U.S. Cl. CPC G06T 19/006; G02B 5/18; G02B 27/4205

(57) ABSTRACT

The present technical solution relates in general to the field of computer engineering, and more particularly to displays or screens for forming an augmented or mixed reality image. The technical result is that of increasing image transfer efficiency, as well as increasing the colour uniformity of a virtual image by repeatedly reusing image rays incoupled into a waveguide from one or several projectors from different directions about the perimeter of an outcoupling diffractive element.

### FIELD OF THE INVENTION

The present technical solution relates in general to the field of computer engineering, and more particularly to displays and screens for creating an augmented or mixed reality image.

### BACKGROUND

The information source U.S. 2017/0299864 A1 is known from the prior art (patent holder: MICROSOFT TECHNOLOGY LICENSING LLC, publ. 19.10.2017). The information source discloses the general principle of creating a display for forming an augmented or mixed reality image. This solution describes a display for forming an augmented or mixed reality image, consisting of: a group of diffractive components for in-coupling image rays into a waveguide and for distributing said rays; a waveguide for propagating image rays; a group of diffractive components that out-couple image rays towards the user’s eyes and distribute the image rays throughout the entire volume of the element; an image projector.

Also, patent application No. U.S. 2019/0056593 A1 (applicant: TIPD LLC), publ. 21.02.2019 is known from the prior art, that discloses a display for forming an augmented or mixed reality image, consisting of: a group of diffractive components for in-coupling image rays into a waveguide and for distributing said rays; a waveguide for propagation of image rays; groups of diffractive components that out-couple image rays towards the user’s eyes and distribute image rays over the entire area of the element; an image projector. Said information source uses holographic optical elements. Also in this patent, the output optical element does not distribute the rays over the volume of the element, but an additional “Y-expander” is used for this purpose.

The potential differences of the current invention comparing to the prior art are in the design of the input and output diffractive elements. Although the structure of these elements is similar to analogues, but in the present solution, the input diffractive element surrounds the output diffractive element around the entire perimeter, which ensures in-coupling of image rays from different directions. The input diffractive element also replicates the image pupil before the image pupil reaches the output diffractive element. At the same time, the output diffractive element also replicates the image pupil. Thus, the efficiency of replication is doubled through the hybrid pupil replication mechanism. The input and output diffractive elements consist of optical gratings that work in conjuction with each other in the sense that their periods and mutual orientation are matched in such a way that the input diffractive element also partially returns the image rays running to the edges of the waveguide.

### SUMMARY OF THE INVENTION

The technical task or technical problem solved in this technical solution is formation of an augmented reality image. More specifically, the design of a device that transmits the image formed by a miniature projector to the user’s eyes, wherein the device itself is transparent and does not block the view of the surrounding world.

The achieved technical result is the increased efficiency of image transmission, as well as increased color uniformity of the virtual image due to the multiple reuse of the image rays in-coupled into the waveguide from one or more projectors from different directions along the perimeter of the output diffractive element.

Also, due to the structure of the input diffractive element, which encircles the output diffractive element around the perimeter, replication of the image pupil and in-coupling of image rays into the waveguide along the perimeter of the waveguide takes place already at and immediately after interaction of the image rays formed by the projector with the input diffractive element. The input diffractive element also provides a partial return of the image rays running to the edges of the waveguide.

### BRIEF DESCRIPTION OF THE DRAWINGS

FIG. 1a shows options for structuring waveguide surfaces to create input and output diffractive elements.

FIG. 1b shows the same options as in FIG. 1a, but with the diffraction elements created inside a functional optical coating which is applied on top of the waveguide surface.

FIG. 2 shows the general structure of the device, its elements are marked as follows: 210 - a group of input diffractive components, 220 - a waveguide, 230 - a group of output diffractive components.

FIG. 3 shows embodiments of the final device, augmented or mixed reality glasses or screen, showing the design flexibility for the diffractive components placement.

FIG. 4 shows embodiments of the final device, augmented or mixed reality glasses or screen, shows a waveguide integrated into the frame of the glasses, shows the design flexibility to allow the image projector to be mounted at several positions.

FIG. 5 shows operation principle of the device with a duplicate input diffractive element located on the opposite surface of the waveguide.

FIG. 6 shows the structure of the diffraction grating of the input and output diffractive elements, options for the mutual orientation of the diffraction gratings are indicated.

FIG. 7 shows operation principle of the input diffractive element, the main directions of diffraction are indicated.

FIG. 8 shows the vector space in the x-y plane, diffraction orders of the input and output diffractive elements are indicated for the case when the angle of rotation of their diffraction gratings relative to each other is 0 degrees, the wave vectors corresponding to the image rays are indicated, the maximum permitted values of the wave vector are shown.

FIG. 9 shows the vector space in the x-y plane, the diffraction orders of the input and output diffraction element are indicated for the case when the angle of rotation of their diffraction gratings relative to each other is 45 degrees, the wave vectors corresponding to the image rays are indicated, the maximum permitted values of the wave vector are shown.

FIG. 10 shows the range of the angles of the image rays formed by the projector, image field of view is also indicated.

### DETAILED DESCRIPTION OF THE INVENTION

The terms and their definitions used in the description of this technical solution will be defined and discussed below to aid understanding how the device operates.

Waveguide is a device in the form of a channel, pipe, rod, etc., designed to propagate sound or electromagnetic waves.

This technical solution, which is a device, consists of, but not limited to, three elements.

The waveguide is a flat or curved optical glass or plastic. The curved waveguide is used to improve the ergonomics of the device, in the same way as the curved lenses of ordinary glasses follow the shape and profile of the human face and eyes, or as curved glasses are used in the aircraft windows, however, technically, the curved augmented reality waveguide is more difficult to implement.

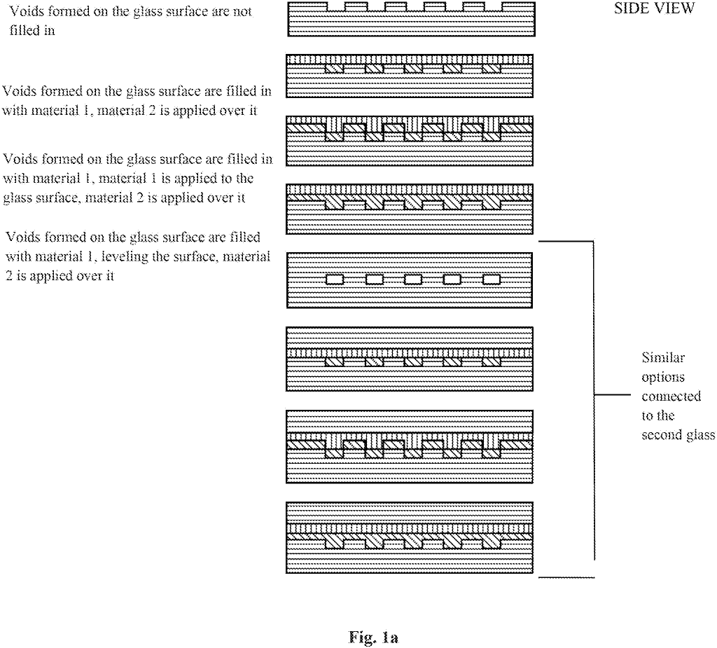

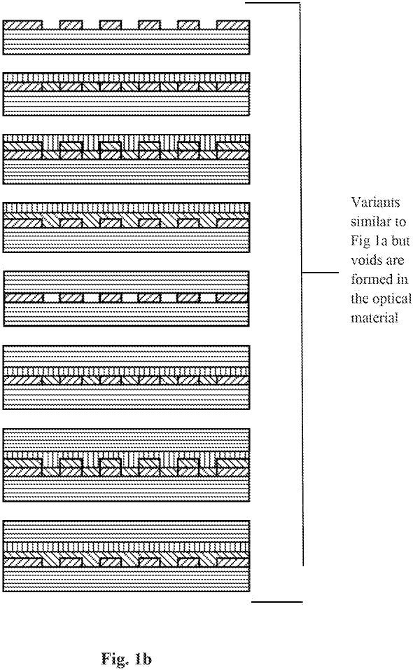

Diffractive components (gratings) in some implementations can either be created directly in the glass body by structuring its surface, top or bottom (for example, by applying a mask and subsequent etching), or in the volume of the waveguide. When a diffraction grating is created in the volume of the waveguide, it is necessary to first create a diffraction grating on the surface of one glass and then bond (for example, by gluing or welding) to the second glass. In another embodiment, a functional optical coating is applied to the glass surface (for example, a layer of SiN or TiO2 is deposited), the diffractive structure is then created in this coating, for example, by the same etching. The functional coating can be multi-layered and consist of several layers. A diffractive structure can also be created in a functional layer placed between two glasses. First, a layer is deposited on one of the glass surfaces, then a diffractive structure is etched into the layer, then this glass is bonded (for example, by gluing or welding) to the second glass. With this bonding, the etched voids can be filled in with a material with a refractive index different from that of glass, so that the surface is once again flat and smooth, as it is shown in FIG. 1.

Such a material in some implementations may be, for example, SiO2, ZnO, or GaP. Materials could be swapped: SiO2, ZnO, GaP can be used for optical coating, and SiN and TiO2 - for filling voids. In general, any arbitrary combination of the listed materials can be used, as long as the refractive indices of the selected materials differ from each other. Metals such as AI, Pt, Au can also be used, either in combination with the above materials or on their own. The thickness of the deposited layers which fill the voids could be greater than the depth of the voids, i.e. the material fills in the voids and forms an additional layer on top. This is necessary because when depositing the filling material, the voids may not be filled evenly, however, if a thicker layer is deposited, it can level the surface. In another embodiment, both the functional layer and the void-filling material could be multi-layered. Each of the layers can have an arbitrary thickness and consist of one of the above materials or any other material suitable for creating optical components.

It is also possible that a metal, such as Au, Pt, Al, is used as the functional layer or coating. In this embodiment, the area covered with metal becomes opaque, but has a higher efficiency of diffraction orders. This option is applicable, for example, to create an input diffractive element 210 with increased efficiency, when its transparency is not required in accordance with the design of the final device. Also, this way, stand-alone high efficient areas of the output diffractive element 230 can be created, while their size should remain small not to obstruct the view of the surrounding world.

In an embodiment where the diffractive components are created on the surface of the waveguide, the diffractive components could be created on both surfaces of the waveguide. In this case, the design of the diffractive components created on the top surface of the waveguide may differ from the design of the diffractive components created on the bottom surface of the waveguide. In this way, extended functionality and implementation flexibility of the final device (augmented or mixed reality display) is achieved, since the optical response of the device from the diffractive components on the top surface of the waveguide, is complemented by the optical response from the diffractive components on the bottom surface of the waveguide. When creating diffraction gratings on the glass surface without bonding, it is not necessary to fill in the etched voids, because they are already filled with the air. Similarly, the voids may not be filled in when bonding two glasses. In yet another embodiment, the diffractive elements can be created by performing a holographic recording of the desired optical response in a holographic coating deposited on the waveguide surface or embedded in the volume of the waveguide. Optical response of the holographic diffraction grating is achieved by spatially modulating optical properties of the holographic coating (or spatially changing the dielectric and magnetic permeability of the material) and is equivalent or identical to the optical response of the diffraction gratings described above and below. Various implementations are shown in FIG. 1a and FIG. 1b.

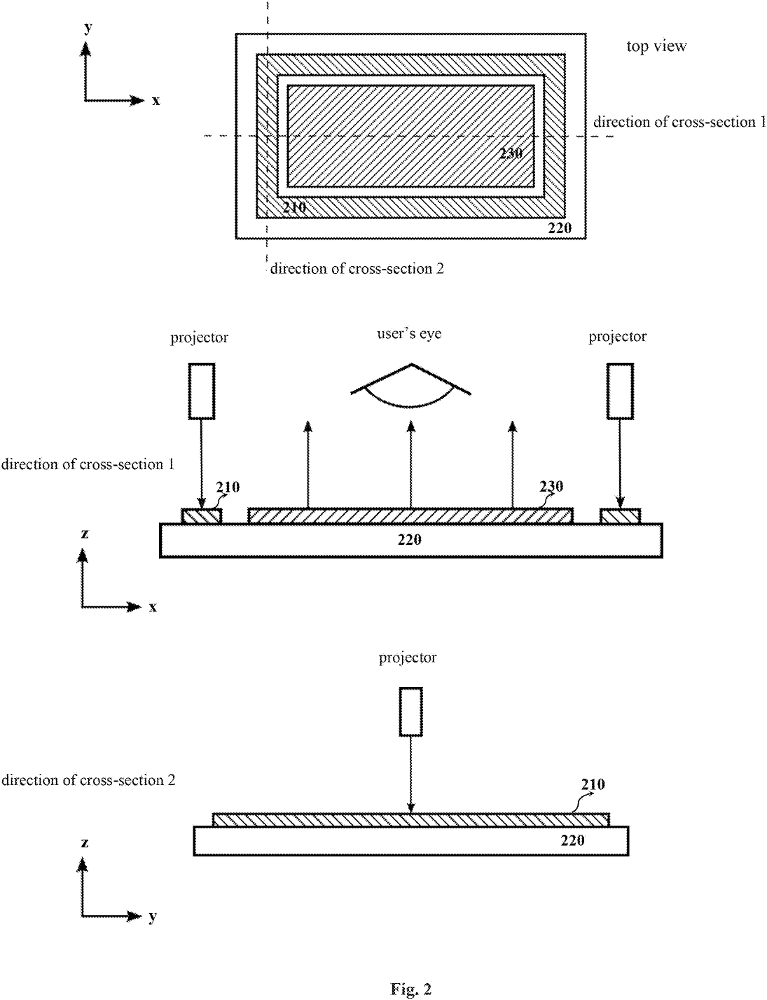

As it was mentioned above, most commonly, the augmented and mixed reality device consists of the following components, as shown schematically in FIG. 2:
a group of diffractive components 210 for (a) in-coupling image rays into the waveguide and for distributing said rays and (b) partial return of the runaway image rays back to the waveguide (hereinafter referred to as the input diffractive element);
a waveguide 220 for propagating image rays;
a group of diffractive components 230 that (a) out-couple image rays towards the user’s eyes and (b) distribute image rays throughout the entire volume of the waveguide (220) (hereinafter referred to as the output diffractive element).

Partial return is understood as a situation when part of the rays which propagate towards the edges of the waveguide (and therefore being lost because, having reached the edge of the waveguide, these rays will leave the waveguide not in the direction of the user’s eyes, and therefore will not provide a useful effect) will be redirected back in the direction of the output diffraction grating and after interacting with the output grating will be directed to the user’s eyes.

As user’s eyes move, the augmented and mixed reality device will be seen by the user at different angles depending on the position of the user’s eyes. The upper and lower limit of the angles of the relative position of the device and the user’s eyes depends on the specific geometry of the end device (for example, augmented reality glasses or screen). In some embodiments, the device may be implemented as a transparent screen, such as glass installed in a window of a house, car, shop window, or used as a transparent display, such as at the check-in counters. The output diffractive element 230 should be located within the user’s field of view in which the virtual image is formed, otherwise, part of the virtual image could be lost.

FIG. 2 shows a general schematic of the device. Geometric shape, relative orientation, and distance between the elements 210 and 230 in the x-y plane can be any, while the output diffractive element occupies most of the waveguide in the x-y plane, and the input diffractive element surrounds it along the perimeter. The input and output diffraction elements can be divided into zones, and some selected zones may be not structured and do not contain a diffraction grating. This feature is necessary for the flexibility of the design ergonomics. For example, zones that overlap with other structural elements of the device (e.g., with the frame holding the waveguide lens) may be intentionally left blank. In the ideal case, i.e. when the maximum performance is achieved, the input diffraction grating 210 encircles the output diffraction grating 230 over the entire period without the presence of empty zones. Blank zones could be created if there is an overlap of the diffractive elements with other elements of the device (i.e physical contact), however the optical response of the device is degraded. Different zones may contain different types of diffraction grating, described below. This allows to achieve the required optical response.

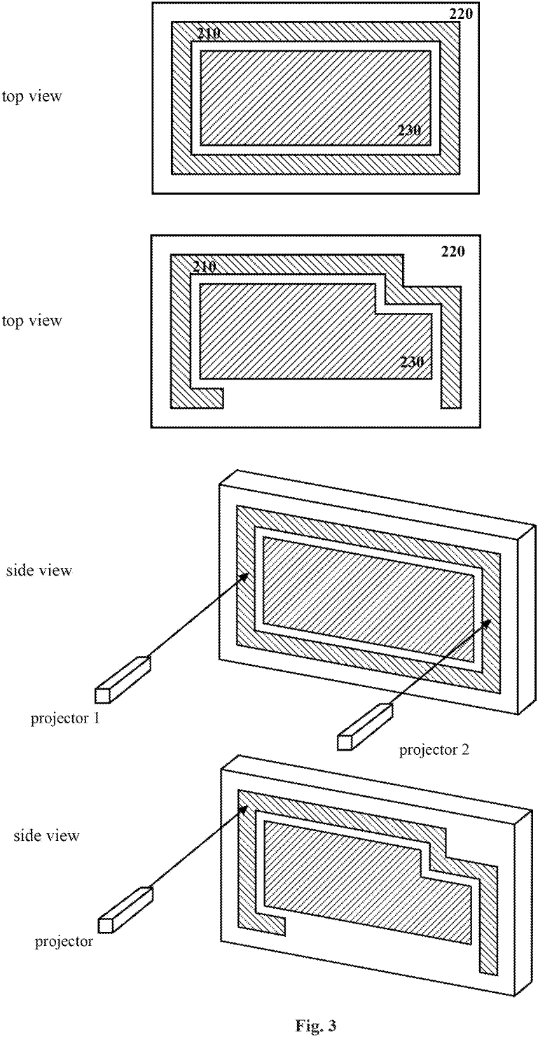

The projector or multiple projectors could be mounted at any position opposite the input diffractive element area such that the image pupil produced by the projector lands on the input diffractive element area as shown in FIG. 2 and FIG. 3

FIG. 3 shows two specific examples of the implementation of the technical solution. In the first version, the input diffractive element encircles the output diffractive element along the entire perimeter. Two projectors are used to project an image pupil at the center of the input diffractive element symmetrically on the left and right sides. In the second version, the input and output diffractive elements are divided into zones, some zones are empty (empty zones are not shown in the figure, but should be clear from a comparison of the figures), one projector is used to project the image pupil onto the upper left-hand corner. In the second option, the efficiency of the system is reduced, however, as described below, empty zones may be necessary for integration into the final device, for example, augmented reality glasses.

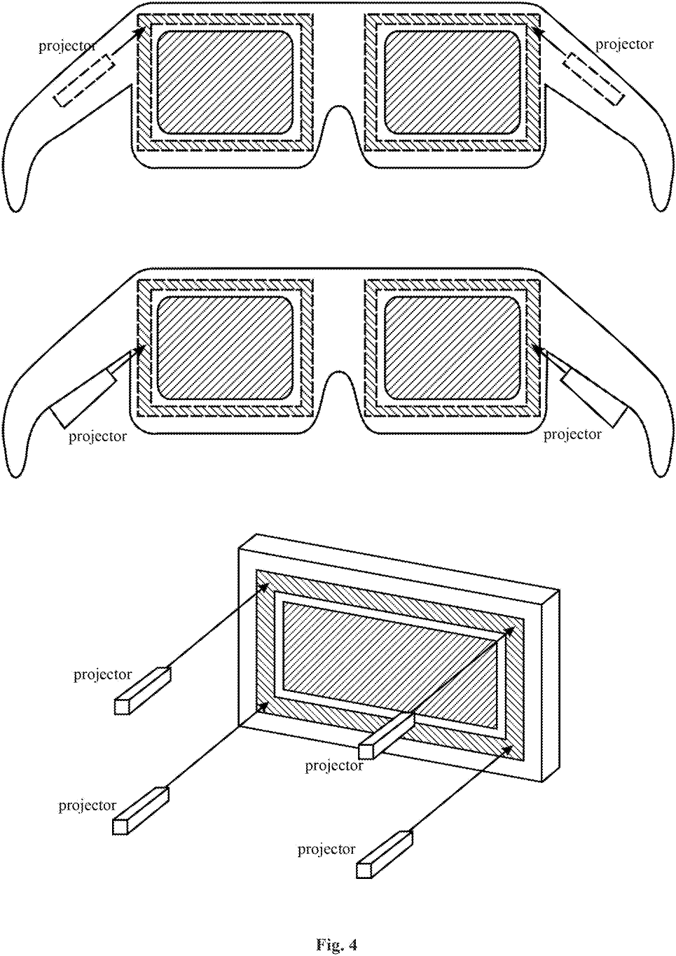

When the waveguide 220 is embedded in, for example, eyeglasses as shown in FIG. 4, the top surface of the waveguide, containing diffractive elements 210 and 230 (if only the top surface is structured), faces either the wearer’s eyes or the opposite direction. In the first case, the virtual image will be formed by diffraction orders in transmission (i.e., rays are used in such way that after diffraction they exit the waveguide 220 into the air), and in the second case, by diffraction orders in reflection (i.e., rays are used in such way that after diffraction they are reflected back into waveguide 220 and exit the waveguide 220 reaching the opposite surface of the waveguide 220). For example, a miniature image projector 240 could be integrated into the eyeglasses. The projector then projects the image onto the top corner of the input diffractive element 210 as it is shown in the first embodiment of FIG. 4, the output diffractive element 230 is positioned in front of the user’s eyes. If, on the other hand, the projector is mounted under the eyeglasses, as it is shown in the second embodiment in FIG. 4, the image pupil is projected at the center of the input diffractive element 210 symmetrically on the left and right sides. Image rays formed by the projector 240 could be projected onto the input diffractive element 210 in both transmission and reflection, depending on the location of the projector and the orientation of the top (or bottom) surface with respect to the user’s eyes. A detailed description of the operation of the input diffractive element 210 is given below. The output diffractive element 230 is located in front of the user’s eyes. Thus, in this design the input diffractive element 210 encircles the output diffractive element along the perimeter and provides flexibility in the implementation of the final device, for example, glasses or an augmented reality screen. In FIG. 4 the third embodiment is shown which is an augmented reality screen, which, for example, can be used at check-in counters or as a personal work display. In this embodiment, several projectors are used that can be located anywhere along the perimeter of the waveguide, while each of the image pupils formed by the projectors should land on the area of the input diffractive element 210. By using multiple projectors, the image brightness and color uniform can be increased. The latter is achieved due to a more uniform distribution of the image rays over the area of the output diffractive element by in-coupling the rays into the waveguide 220 from several directions. The projectors in the third embodiment of FIG. 4 are shown schematically, in a real device, the projectors can be mounted in the screen frame on the front or back side. The size of the input diffractive element 210 is selected depending on the size of the image pupil formed by the projector or multiple projectors 240, and the size and location of the output diffractive element 230.

The size of the output diffractive element 230 is determined by three factors - the size of the image field of view (formed by the projector 240, the larger the image field of view (in other words, the range of the angles of the image rays created by the projector 240), the larger is the size of the image that the user sees), the distance from the output diffractive element 230 to the user’s eyes and the required (or inherent in the design) size of the zone of allowable deviations of the position of the user’s eyes from a given central position (known as eye box). In some embodiments, the size of the output diffractive element 230 could reach, for example, 4x4 cm or 4x6 cm or 20x20 cm, 100x50 cm or more. The eye-to-glass distance is determined by the design of the final device - by the frame size, etc. The center of the output diffractive element 230 could be in front of the user’s eye, typically on a line perpendicular to the surface of the waveguide 210, but depending on the ergonomics of the final device, this line may pass at a certain angle. In general, the output diffractive element 230 should overlap the area of the user’s field of view in which the virtual image is formed. In the case where the device is implemented as an augmented reality screen, the output diffractive element 230 occupies the maximum surface area of the screen.

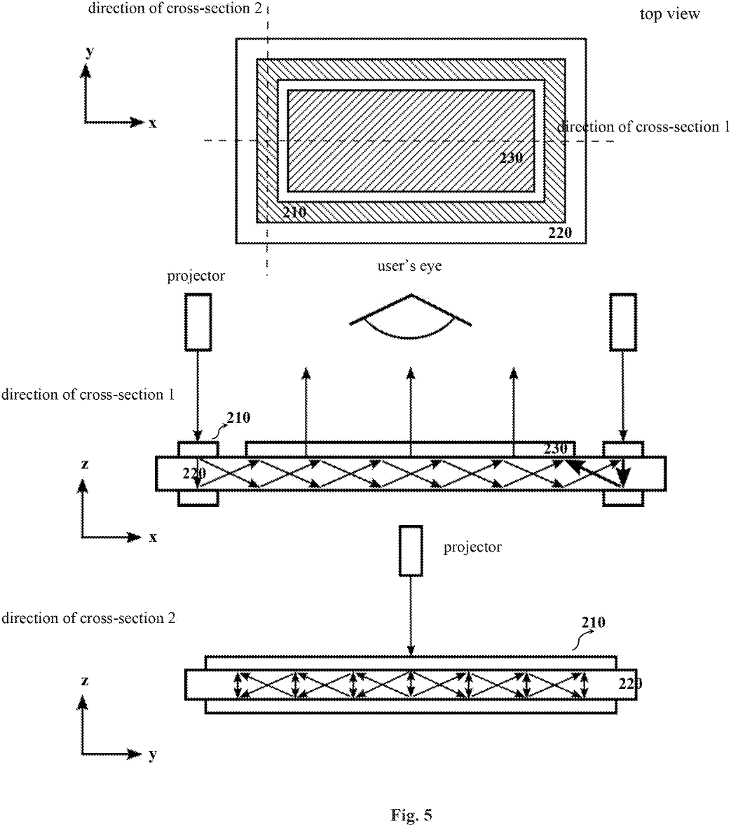

The input diffractive element 210 also performs a partial return of the runaway image rays back into the waveguide, as it is described in more detail below. A duplicate copy of the input diffractive element 210 can be created on the opposite surface of the waveguide 220 as it is shown in FIG. 5. In this embodiment, the runaway image rays that, upon interaction with the input diffractive element 210, were previously redirected towards the opposite surface of the waveguide and exited the waveguide, are now redirected back into the waveguide as it is shown by the bold arrows in FIG. 5. In this case, initial coupling of the image rays formed by the projector 240 is carried out by the input diffractive element 210 located on both surfaces of the waveguide 220.

A detailed description of the individual components is given below and includes a description of how they operate.

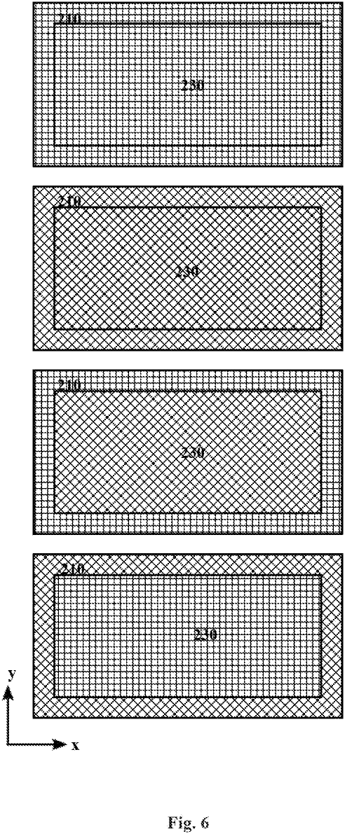

The input diffractive element 210 and the output diffractive element 230 comprise square two-dimensional optical gratings rotated relative to each other by any multiple of 45 degrees as it is shown in FIG. 6. There are four options for the location and orientation of the elements 210 and 230 relative to each other and relative to the x-axis. In the first embodiment, the square arrays of the elements 210 and 230 are rotated by 0 degrees relative to the x-axis and by 0 degrees relative to each other. In the second embodiment, the square arrays of the elements 210 and 230 are rotated by 45 degrees relative to the x-axis and by 0 degrees relative to each other. In the third version, the square grating of the element 210 is rotated relative to the x axis by 0 degrees, the square grating of the element 230 is rotated by 45 degrees relative to the x axis, the angle between the square gratings of the elements 210 and 230 is 45 degrees. In the fourth version, the square grating of element 210 is rotated relative to the x axis by 45 degrees, the square grating of element 230 is rotated by 0 degrees relative to the x axis, the angle between the square gratings of elements 210 and 230 is 45 degrees.

Diffractive arrays of the elements 210 and 230 could be formed by solid lines. It is possible that the lines of the optical grating 210 or 230 are split into elements of a certain shape (for example, cylindrical, cubic, etc., however, elements of different shapes and sizes could be used), becoming discontinuous, which provides control of the efficiency of the diffraction orders. A different shape provides control of the intensity of the diffraction orders, which makes it possible to control the color uniformity of the virtual image. Different shapes give different degrees of control as they could be simpler or more difficult to fabricate. Elements can be layered or slanted, such as a pyramid with steps or sloped sides. Below we describe operation principle of the device using examples of embodiments which were described above. In options two and four, the device works as in options one and three with the x-axis rotated by 45 degrees, in this case the various directions of propagation of the rays which will be described below are rotated by 45 degrees, while the operation principle of the device does not change.

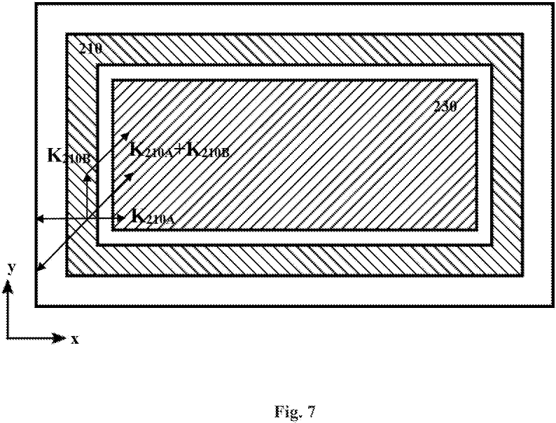

The optical grating of the input diffractive element 210 redirects light from the miniature projector 240 in the directions determined by its diffraction vectors
K210A=2TG*(A210*P/V21O,(A210^{x}P));
K210V=2TT′(V210^{x}P/A210*(V210*P));
where Agu and Vgu are the Bravais grating vectors of the square grating of the input diffractive element 210 as shown in FIG. 7 in the example of the variant one described above. Some of these directions, such as Kgud and Kgud + Kguv, correspond to directions to the output diffractive element 230. Other directions, such as -Kgud and -Kgud - Kguv, cause image rays to run away from the output diffractive element 230; diffraction efficiency in these directions could be minimized by selecting diffractive elements of a certain shape, for example inclined towards the output diffractive element 230.

The optical grating of the input diffractive element 210 redirects the light from the projector 240 also along the perimeter of the output diffractive element 230, in variant one and three this direction is given by the vector Kguv, and then in the direction of the output diffractive element 230 by another diffraction in the direction Kgud + Kguv as shown in FIG. 7. Thus, the input of image rays into the waveguide and their distribution over the area of the waveguide is performed already at the stage of the initial in-coupling of image rays into the waveguide 220.

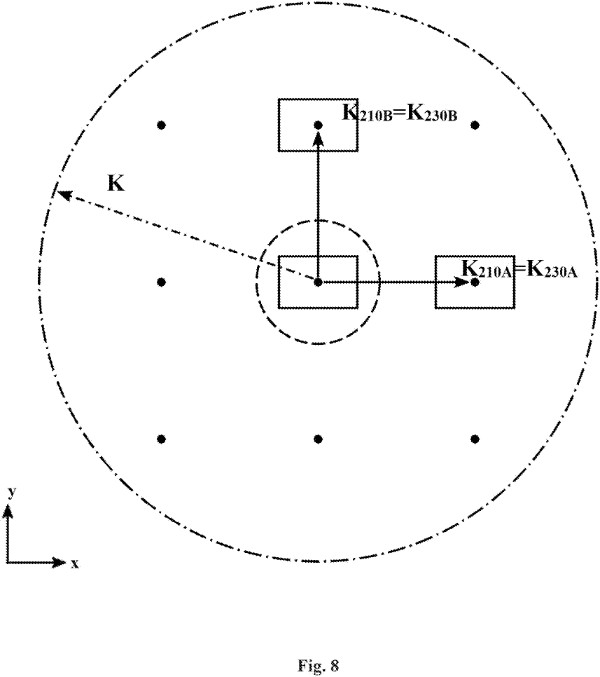

In FIG. 8, the following designations are used. The outer circular contour denotes the maximum allowed value of the wave vector of the diffracted rays in the x-y plane, and this value, in turn, is equal to K=Ko*p2, where Ko is the wave vector of the image rays formed by the projector, p2 is the refractive index of the waveguide. The inner circular contour denotes the minimum value of the wave vector of the diffracted rays in the x-y plane upon reaching which the condition of total internal reflection of the rays in the waveguide 220 is violated. The periodic nodes represent diffraction orders of the square optical grating of the input and output diffraction elements 210 and 230. The square box shows wavevector values of the image rays in the x-y plane formed by the projector before any diffraction (shown at the center of the inner circular contour) and after diffraction events (boxes centered on the nodes of the diffraction orders of the square grating of the elements 210 and 230).

Thus, the input diffractive element 210 in-couples the image rays formed by the projector 240 into the waveguide 220 and directs the image rays in the directions defined by the diffractive nodes shown in FIG. 8 and described above. It can be seen that all nodes enclosed between the outer and inner contours correspond to the allowed diffraction orders, in which case the image rays are in-coupled into the waveguide and propagate at an angle greater than the angle of total internal reflection of the waveguide 220; the angle is measured from the direction perpendicular to the surface of the waveguide.

When interacting with the output diffractive element 230, the wave vector of the image rays is added or subtracted by the wave vector K230A=2TT″(A23O*P/V230,(A230^{X}P)); K230V=2TT*(V230HP/A230*(V210HP)); OR the vector Kgzod + Kgzov, where Agzo and Vgzo are the Bravais vectors of the square grating of the output diffractive element 230. In variant one and three optical gratings of the elements 210 and 230 are equal and the above described vectors are identical to the vectors Kgud, Kguv, and K21 OA + K210V. Thus, after interaction with the output diffractive element 230, the resulting wave vector has a component in the x-y plane which corresponds to one of the nodes depicted in FIG. 8. The image rays which correspond to all nodes except of the central node continue to propagate inside the waveguide in the respective directions. Image rays which correspond to the central node are out-coupled towards the user’s eyes.

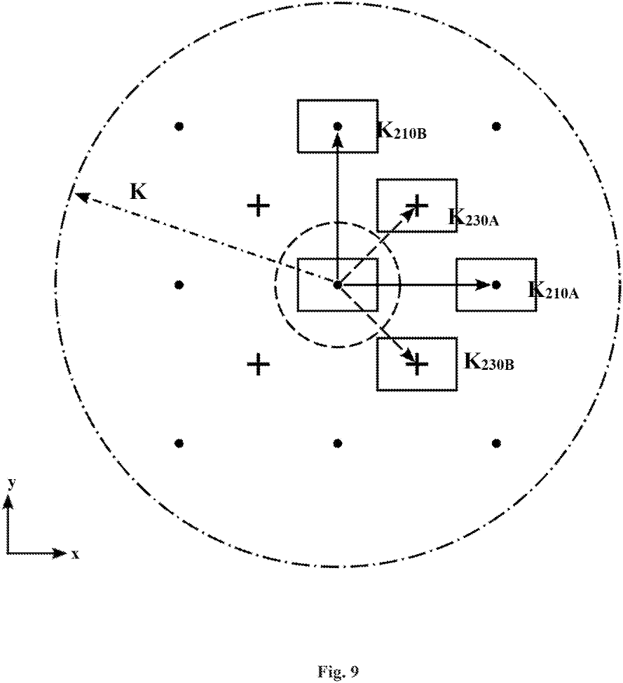

In variants two and four, the optical grating of the output diffractive element 230 has a period of 2^{1/2} times the period of the optical grating of the input diffractive element 210. As it was described above, the optical gratings of the elements 210 and 230 are rotated by 45 degrees relative to each other. The optical grating of the output diffractive element 230 has diffraction orders indicated by the cross nodes in FIG. 9.

Thus, after interaction with the output diffractive element 230, the resulting wave vector has a component in the x-y plane corresponding to one of the nodes depicted in FIG. 9. It can be seen that transitions are allowed only between the depicted nodes, and some of the transitions lead to circular nodes, while other transitions lead to the cross nodes. The image rays which correspond to all nodes except of the central node continue to propagate inside the waveguide in the respective directions. Image rays which correspond to the central node are out-coupled towards the user’s eyes.

As it can be seen from FIG. 8 and FIG. 9, after interacting with the output diffractive element 230, some of the image rays propagate towards the edges of the waveguide and, having reached the edges, diffract on the optical grating of the input diffractive element 210. As a result, some of the rays are redirected back towards the output diffractive element 230. The return directions are determined by the resulting component of the wave vector of the image rays in the x-y plane, which corresponds to one of the transitions between the nodes shown in FIG. 8. and FIG. 9. This way, the loss of image rays is partially prevented. To increase the efficiency of the input diffractive element 210 for in-coupling of the image rays from the projector 240 into the waveguide 210, and to increase the efficiency of returning the runaway image rays, the optical grating of the element 210 can be coated with a functional coating, for example, Au, Pt, Al, TiO2, SiO2.

A duplicate copy of the input diffractive element 210 could be created on the opposite surface of the waveguide 220 as shown in FIG. 5. In this embodiment, the image rays that, when interacting with the input diffractive element 210, were previously redirected towards the opposite surface of the waveguide (this direction corresponds to the central diffractive node in FIG. 8 and FIG. 9.) and exited the waveguide are now redirected back into the waveguide as shown in bold arrows in FIG. 5. In this case, initially, the input of the image rays formed by the projector 240 can be performed by the input diffractive element 210 located on both surfaces of the waveguide 220 if a transparent functional coating is used. If, on the other hand, Au, Pt, Al metal coating is used in combination with a duplicate copy of the input diffractive element 210, then the areas that the image pupil formed by the projectors 240 land on should be coated with a transparent functional coating, or should not use coatings on at least one of the surfaces. Otherwise, the image rays will be blocked and will not be in-coupled into the waveguide 220.

Replication of the image pupil (formed by the projector 240) is done according to the standard scheme of operation of such devices and is known from the prior art (in the sense that the image pupil is replicated over the volume of the waveguide 220, technically this can be implemented in different ways). A particular image ray produced by the projector 240 “splits” into N rays upon each interaction with the diffraction grating. Thus, if we consider the entire set of image rays in the image pupil, copies of the image pupil are formed upon interaction with the diffraction grating which propagate in multiple new directions comparing to the propagation of the parent image pupil. These propagation directions are determined by the diffraction vectors of the input and output diffractive elements 210 and 230 as it was described above. Replication of the image pupil throughout the entire volume of the waveguide 220 is required so that the user could see a virtual image regardless of the position of their eyes in relation to the waveguide 220, and hence the lens of the glasses or the screen. That is, it is required that at least one image pupil which is the source of a particular image ray with a given angle in the image field of view is always in the field of view of the user.

Also, to achieve a full color picture, it may be necessary to create three diffractive waveguides 220, each for one of the RGB colors. Then all three waveguides 220 are connected in a “stack”, i.e. stacked one above the other. In this case a flexibility is needed in where and on what surface the input grating is located.

Element 210 can operate both in reflection mode (image rays first pass through waveguide 220 at an angle less than the angle of total internal reflection before interacting with element 210), and in transmission mode (image rays interact with element 210 at the moment of entering into waveguide 220). In an embodiment where a duplicate copy of the input diffractive element 210 is created on the opposite surface of the waveguide 220, the element 210 can simultaneously operate in both reflection and transmission as it is shown in FIG. 5.

Waveguide 220 could be made of glass, plastic, or any other material suitable for making optical components. Depending on the application, this can be, for example, glass or plastic. An important indicator of such materials is the refractive index (affects the size of the field of view of the virtual image or, in other words, the size of the picture) and transmission over the entire range of visible light (the absorption of light in the visible range should be minimal), as well as how uniform the waveguide 220 is - thickness variations, surface roughness, etc. The smaller the values characterizing the imperfection of the waveguide, the better it is. A lot of other mechanical properties, such as hardness, etc., are not important for optical performance, but may be important for the final device.

Light propagates within waveguide 220 by reflecting at an angle greater than the angle of total internal reflection of the material from which waveguide 220 is made. For example, for waveguide 220 made of glass with a refractive index of 1.5, the range of angles of incidence on the surface of waveguide 220 would be 42 - 90 degrees, and the angle is measured from the normal to the surface of the waveguide 220.

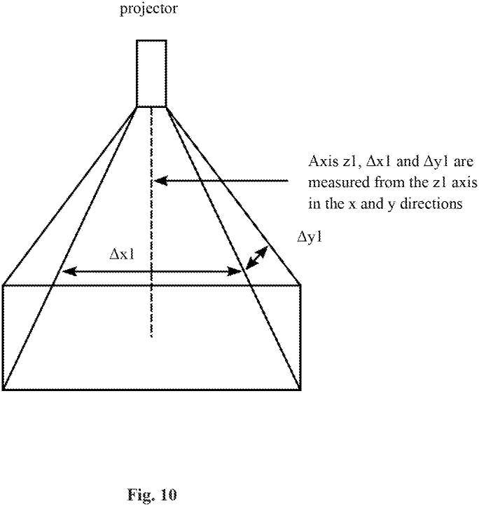

Waveguide surfaces 410 and 420 shown in FIG. 4 may be flat and parallel to each other, or curved while remaining parallel, as required by the ergonomics of the final device. Planar waveguide 220 is technically easier to implement. Surfaces 410 and 420 could be coated with a functional coating, such as an antireflection coating or a coating that changes the angle of the total internal reflection of the surface, to improve the efficiency and performance of the device. Two examples of such coatings are discussed below, an antireflection coating and a refractive index changing coating. The refractive index determines field of view of the virtual image (image size). For example, if the refractive index of glass is 1.5, then the field of view is 30 degrees diagonally, if the refractive index is 1.8 - the field of view is 50 degrees diagonally. Image aspect ratio, for example, is 16:9 in both cases. Anti-reflective coating prevents glare (for example, from the sun or outdoor lights). Another example is a special coating that prevents the out-coupling of the image rays in the direction “away from the user’s eyes”. By default, the output diffractive element 230 out-couples image rays in two directions, namely in the directions towards the top and bottom surfaces of the waveguide 220. In this case, the image which is out-coupled in the direction “away from the user’s eyes” is visible to the surrounding people, which is undesirable. To prevent this effect, a special coating can be used, which will create an asymmetry of the diffraction efficiency in these two directions. The picture displayed “away from the user’s eyes” will not be lost, but will be redirected to the user’s eyes. These functional coatings can be applied both on the top of the already formed diffractive structure and under it, or applied to the glass surface on which the diffractive structure is not formed. Projector 240 may be composed of a light source, such as light emitting diodes (LEDs) or super luminescent light emitting diodes (SLEDs), or may be a laser, combined with LCOS or DMD image forming pixel array. Thus, the rays formed by the projector 240 land on the surface of the input grating at a set of angles Dc1 and Au1 counted from the z1 axis, which define field of view of the virtual image (image size). As an implementation example for a 16:9 image format and a 30 degree diagonal field of view: Dc1 = ±13, Au1=±1:7. A “bundle” of these rays is in-coupled into the waveguide and propagates in the waveguide under a new set of angles Dc2 and Au2, but now measured from the axis z2 passing at an angle Z0 to the z1 axis. The angle Z0 is determined by the equation d*(sin02 - sinZ0) = L/n2 where c1=2tt/k ray, sinO2*n2=sinO1*n1, n2 is the refractive index of glass, n1 is the refractive index of the environment (air), L is the operating wavelength of the waveguide 220, O1 is the angle of the z1 axis with respect to the surface normal of the waveguide 220, as it is shown in FIG. 10.

This “bundle” of rays interacts with the output grating 230. Since the image rays land on the output grating under the set of angles Dc2 and Au2 measured from the z2 axis, it is important that the intensity of the diffracted rays has a minimal dependence on the angles of incidence Dc2 and Au2. This ensures improved color uniformity of the created virtual image. As described above, the virtual image consists of the rays formed by the projector 240 with a certain range of angles. Upon entering waveguide 220, this set of angles is converted as described above. Hereinafter, all these rays interact with the output diffraction grating 230. Let us define the efficiency function of this interaction as F (Dc2, Lu2). Further, F (Dc2, Lu 2) = C, where C is a fixed value, independent of Dc2, Lu2. In this case, the color balance of the image is not distorted. In a particular implementation, C is not a constant, but its dependence on Dc2, Lu2 is minimized by multiple reuse of image rays which propagated at different angles as described above. In other words, the dependence of C on yDx2, Du2 is averaged due to the fact that all rays interact with the output diffraction grating 230 many times and from different directions.

Elements 210 and 230 can be divided into an unlimited number of zones of arbitrary shape and size. The element 230 may be fabricated on one or both surfaces of the waveguide 220 or within its volume as it was described above.

As it will be understood by a person skilled in the relevant technical art, aspects of the present technical solution can be implemented in the form of a device. Accordingly, various aspects of the present technical solution may be implemented solely as hardware and some as software (including application software and so on) or as an embodiment combining software and hardware aspects, which may be generally referred to as “module”, “system” or “architecture”. In addition, aspects of the present technical solution may take the form of a computer program product implemented on one or more computer-readable media having computer-readable program code embodied thereon.

1. An augmented and mixed reality display, comprising a housing, which includes
a set of input diffractive components composed of a square diffraction grating configured to in-couple image rays into the waveguide and distribute said rays into at least one direction;
waveguide configured to propagate image rays;
a set of output diffractive components composed of a square diffraction grating configured to out-couple image rays towards the user’s eyes and distribute the image rays throughout the entire volume of the waveguide into at least three directions;
a set of input diffractive components which encircles or partially encircles a set of output diffractive components and returns or partially returns runaway image rays into the waveguide.

2. The augmented and mixed reality display according to claim 1, characterized in that when the runaway image rays return, part of the rays running to the edges of the waveguide are redirected back in the direction of the output diffraction grating and, after interacting with the output diffraction grating, are directed into the user’s eyes.

3. The augmented and mixed reality display according to claim 1, characterized in that the diffractive element for out-coupling image rays is present within user’s field of view in which a virtual image is formed.

4. The augmented and mixed reality display according to claim 1, characterized in that the output diffractive element occupies most of the waveguide, and the input diffractive element encircles it along the perimeter.

5. The augmented and mixed reality display according to claim 1, characterized in that the input and output diffractive elements are divided into zones.

6. The augmented and mixed reality display according to claim 1, characterized in that the input diffraction grating encircles the output diffraction grating over the entire perimeter without the presence of empty zones or with empty zones.

7. The augmented and mixed reality display according to claim 1, characterized in that in the case when the waveguide is embedded into glasses, the top surface containing the input and output diffractive elements faces either towards the user’s eyes, or in the opposite direction.

8. The augmented and mixed reality display according to claim 1, characterized in that the output diffractive element is located in front of the user’s eyes.

9. The augmented and mixed reality display according to claim 1, characterized by the fact that it is used at check-in counters or as a personal work display.

10. The augmented and mixed reality display according to claim 1, characterized in that the size of the input diffractive element is selected depending on the size of the image pupil formed by the projector or several projectors and the size and location of the output diffractive element.

11. The augmented and mixed reality display according to claim 1, characterized in that a duplicate copy of the input diffractive element is created on the opposite surface of the waveguide.

12. The augmented and mixed reality display according to claim 1, characterized in that the in-coupling of the image rays formed by the projector is carried out by an input diffractive element located on both surfaces of the waveguide.

13. The augmented and mixed reality display according to claim 1, characterized in that the input diffractive element and the output diffractive element contain two-dimensional square gratings rotated relative to each other at an angle which is a multiple of 45 degree.

14. The augmented and mixed reality display according to claim 1, characterized in that the optical gratings of the input diffractive element and the output diffractive element are formed by solid lines.

15. The augmented and mixed reality display according to claim 1, characterized in that the lines of the optical grating of the input diffractive element and the output diffractive element are divided into separate elements of a certain shape.

16. The augmented and mixed reality display according to claim 1, characterized in that the optical grating of the input and output diffractive display redirects light from a miniature projector in the direction determined by its diffraction vectors.

17. The augmented and mixed reality display according to claim 1, characterized in that the output diffractive element is formed on both surfaces of the waveguide.
